(19) United States
(12) Patent Application Publication
(10) Pub. No.: US 2020/0286702 A1
(43) Pub. Date: Sep. 10, 2020

(54) CONTACT MODULE, CONTACT DEVICE, ELECTROMAGNETIC RELAY MODULE, AND ELECTRICAL DEVICE

(71) Applicant: PANASONIC INTELLECTUAL PROPERTY MANAGEMENT CO., LTD., Osaka (JP)

(72) Inventors: Kazuhiro KODAMA, Hokkaido (JP); Ryosuke OZAKI, Osaka (JP); Shinya KIMOTO, Osaka (JP); Seiya SAKAGUCHI, Hokkaido (JP); Yasutaka HIEDA, Osaka (JP)

(73) Assignee: PANASONIC INTELLECTUAL PROPERTY MANAGEMENT CO., LTD., Osaka (JP)

(21) Appl. No.: 16/765,792

(22) PCT Filed: Nov. 21, 2018
(86) PCT No.: PCT/JP2018/043068

§ 371 Date: May 20, 2020

(30) Foreign Application Priority Data
Nov. 27, 2017 (JP) 2017-227289

(51) Int. Cl. H01H 50/60; H01H 1/54; H01H 50/10; H01H 50/14

(52) U.S. Cl. CPC H01H 50/60; H01H 50/14; H01H 50/10; H01H 1/54

(57) ABSTRACT

A contact module includes a pair of contact devices, each of which includes a fixed terminal and a moving contactor. The moving contactor moves from a closed position where the moving contact is in contact with the fixed contact to an open position where the moving contact is out of contact with the fixed contact, and vice versa. One moving contactor generates, when energized, a magnetic field that applies force to the other moving contactor in a direction from the open position of the other moving contactor toward the closed position of the other moving contactor. The other moving contactor generates, when energized, a magnetic field that applies force to the one moving contactor in a direction from the open position of the one moving contactor toward the closed position of the one moving contactor.

### TECHNICAL FIELD

The present disclosure generally relates to a contact module, a contact device, an electromagnetic relay module, and an electrical device, and more particularly relates to a contact module, a contact device, an electromagnetic relay module, and an electrical device, all of which are configured to selectively bring a moving contact into contact, or out of contact, with a fixed contact.

### BACKGROUND ART

Patent Literature 1 discloses a contact device for selectively passing, or cutting off, an electric current through/at a contact.

Specifically, the contact device disclosed in Patent Literature 1 causes a moving contactor, included in the contact device, to be moved by electromagnetic force generated by energizing an excitation coil (excitation winding) of an electromagnet device, thereby bringing the moving contact of the moving contactor into contact with a fixed contact of a fixed terminal included in the contact device. This allows the moving contactor to be connected to the fixed terminal.

In the contact device described above, when an abnormal electric current such as a short-circuit current flows, for example, Lorenz force (i.e., electromagnetic repulsion) is applied to the moving contactor in such a direction as to bring the moving contact out of contact with the fixed contact, thus possibly decreasing the stability of connection between the moving contact and the fixed contact.

### CITATION LIST

### Patent Literature

Patent Literature 1: JP 2014-232668 A

### SUMMARY OF INVENTION

In view of the foregoing background, it is therefore an object of the present disclosure to provide a contact module, a contact device, an electromagnetic relay module, and an electrical device, all of which are configured to increase the stability of connection between the moving contact and the fixed contact.

A contact module according to an aspect of the present disclosure includes a pair of contact devices, which consists of one contact device and the other contact device. The one contact device includes one fixed terminal and one moving contactor. The one fixed terminal holds one fixed contact thereon. The one moving contactor holds one moving contact thereon and moves from a closed position where the one moving contact is in contact with the one fixed contact to an open position where the one moving contact is out of contact with the one fixed contact, and vice versa. The other contact device includes the other fixed terminal and the other moving contactor. The other fixed terminal holds the other fixed contact thereon. The other moving contactor holds the other moving contact thereon and moves from a closed position where the other moving contact is in contact with the other fixed contact to an open position where the other moving contact is out of contact with the other fixed contact, and vice versa. The pair of contact devices is arranged such that a direction in which the one moving contactor of the one contact device moves from the open position toward the closed position and a direction in which the other moving contactor of the other contact device moves from the open position toward the closed position are opposite from each other. The one moving contactor generates, when energized, a magnetic field that applies force, in a direction from the open position of the other moving contactor toward the closed position of the other moving contactor, to the other moving contactor, through which an electric current is flowing. The other moving contactor generates, when energized, a magnetic field that applies force, in a direction from the open position of the one moving contactor toward the closed position of the one moving contactor, to the one moving contactor, through which an electric current is flowing.

A contact module according to another aspect of the present disclosure includes: a pair of contact devices consisting of one contact device and the other contact device; and a magnetic shield member having magnetic properties. The one contact device includes one fixed terminal and one moving contactor. The one fixed terminal holds one fixed contact thereon. The one moving contactor holds one moving contact thereon and moves from a closed position where the one moving contact is in contact with the one fixed contact to an open position where the one moving contact is out of contact with the one fixed contact, and vice versa. The other contact device includes the other fixed terminal and the other moving contactor. The other fixed terminal holds the other fixed contact thereon. The other moving contactor holds the other moving contact thereon and moves from a closed position where the other moving contact is in contact with the other fixed contact to an open position where the other moving contact is out of contact with the other fixed contact, and vice versa. The pair of contact devices are arranged such that a direction in which the one moving contactor of the one contact device moves from the open position toward the closed position and a direction in which the other moving contactor of the other contact device moves from the open position toward the closed position are opposite from each other. The one moving contactor generates, when energized, a magnetic field that applies force, in a direction from the closed position of the other moving contactor toward the open position of the other moving contactor, to the other moving contactor, through which an electric current is flowing. The other moving contactor generates, when energized, a magnetic field that applies force, in a direction from the closed position of the one moving contactor toward the open position of the one moving contactor, to the one moving contactor, through which an electric current is flowing. The magnetic shield member is arranged between the one moving contactor and the other moving contactor.

A contact device according to still another aspect of the present disclosure is included in the contact module described above.

An electromagnetic relay module according to yet another aspect of the present disclosure includes: the contact module described above; and a pair of electromagnet devices consisting of one electromagnet device and the other electromagnet device. The one electromagnet device moves the one moving contactor, while the other electromagnet device moves the other moving contactor.

An electrical device according to yet another aspect of the present disclosure includes: the electromagnetic relay module described above; and a holding member. The holding member holds the electromagnetic relay module such that a direction in which the one moving contactor moves from the open position toward the closed position and a direction in which the other moving contactor moves from the open position toward the closed position are opposite from each other.

### BRIEF DESCRIPTION OF DRAWINGS

FIG. 1A is a perspective view of an electromagnetic relay including a contact device according to a first embodiment;

FIG. 1B is a cross-sectional view of the electromagnetic relay taken along the plane X1-X1;

FIG. 2 is a cross-sectional view of the electromagnetic relay taken along the plane X2-X2;

FIG. 3 illustrates how a first yoke and a second yoke of the contact device attract each other;

FIG. 4 illustrates a relative position of the first yoke with respect to a moving contactor;

FIG. 5 illustrates how to stretch an arc generated in the contact device;

FIG. 6 is a circuit diagram illustrating how a contact module according to a first embodiment, a battery, and a load may be connected together;

FIG. 7 is a perspective view of an electrical device according to the first embodiment;

FIG. 8 illustrates relative positions of a moving contactor of one contact device and a moving contactor of the other contact device according to the first embodiment and repulsive forces produced between the moving contactor of the one contact device and the moving contactor of the other contact device;

FIG. 9 illustrates relative positions of one contact device and the other contact device according to a variation of the first embodiment;

FIG. 10 illustrates relative positions of the moving contactor of the one contact device and the moving contactor of the other contact device and attractive forces produced between the moving contactor of the one contact device and the moving contactor of the other contact device;

FIG. 11 illustrates relative positions of a moving contactor of one contact device and a moving contactor of the other contact device according to a second embodiment and attractive forces produced between the moving contactor of the one contact device and the moving contactor of the other contact device; and

FIG. 12 illustrates relative positions of a moving contactor of one contact device and a moving contactor of the other contact device according to a variation of the second embodiment and repulsive forces produced between the moving contactor of the one contact device and the moving contactor of the other contact device.

### DESCRIPTION OF EMBODIMENTS

Note that embodiments and their variations to be described below are only examples of the present disclosure and should not be construed as limiting. Rather, those embodiments and variations may be readily modified in various manners depending on a design choice or any other factor without departing from a true spirit and scope of the present disclosure. It should also be noted that the drawings to be referred to in the following description of embodiments and their variations are all schematic representations. That is to say, the ratio of the dimensions (including thicknesses) of respective constituent elements illustrated on the drawings does not always reflect their actual dimensional ratio.

### First Embodiment

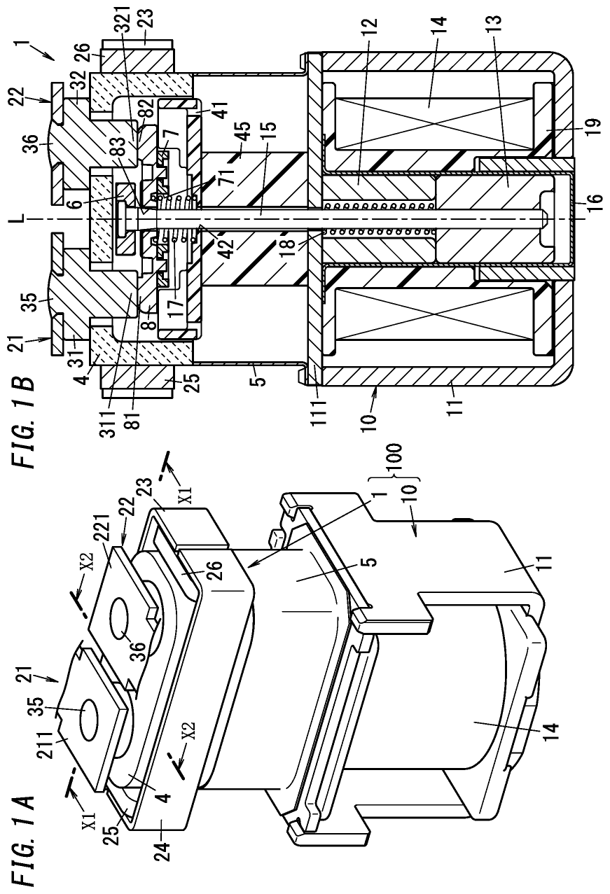

A contact module 91 according to a first embodiment and an electrical device 900 will be described with reference to FIGS. 1A-8.

(1) Configuration

(1.1) Overall Configuration

An electrical device 900 according to this embodiment includes: an electromagnetic relay module 910; and a holding member 920 for holding the electromagnetic relay module 910. The electromagnetic relay module 910 includes: a contact module 91 including a pair of contact devices 1; and a pair of electromagnet devices 10. Each of these contact devices 1 forms, along with an associated electromagnet device 10, an electromagnetic relay 100. In other words, each electromagnetic relay 100 includes an associated contact device 1 and an associated electromagnet device 10. In the following description, when the pair of contact devices 1 need to be distinguished from each other, one contact device 1 will be hereinafter referred to as a “contact device 1A” and the other contact device 1 will be hereinafter referred to as a “contact device 1B.” Likewise, when the pair of electromagnet devices 10 need to be distinguished from each other, one electromagnet device 10 will be hereinafter referred to as an “electromagnet device 10A” and the other electromagnet device 10 will be hereinafter referred to as an “electromagnet device 10B.” Furthermore, when the pair of electromagnetic relays 100 need to be distinguished from each other, one electromagnetic relay 100 will be hereinafter referred to as an “electromagnetic relay 100A” and the other electromagnetic relay 100 will be hereinafter referred to as an “electromagnetic relay 100B.”

Each contact device 1 includes a pair of fixed terminals 31, 32 and a moving contactor 8 (see FIG. 1B). Each of the fixed terminals 31, 32 holds a fixed contact 311, 321 thereon. The moving contactor 8 holds a pair of moving contacts 81, 82 thereon.

Each electromagnet device 10 includes a mover 13 and an excitation coil 14 (see FIG. 1B). The electromagnet device 10 is configured to have the mover 13 attracted by a magnetic field generated by the excitation coil 14 when the excitation coil 14 is energized. Attracting the mover 13 causes the moving contactor 8 to move from an open position to a closed position. As used herein, the “open position” refers to the position of the moving contactor 8 when the moving contacts 81, 82 go out of contact with the fixed contacts 311, 312, respectively. Also, as used herein, the “closed position” refers to the position of the moving contactor 8 when the moving contacts 81, 82 come into contact with the fixed contacts 311, 312, respectively.

Also, in this embodiment, the mover 13 is arranged along a line L and configured to reciprocate straight along the line L. The excitation coil 14 is configured as a conductive wire (electric wire) wound around the line L. That is to say, the line L corresponds to the center axis of the excitation coil 14.

In the embodiment to be described below, each contact device 1 is supposed to form, along with its associated electromagnet device 10, the electromagnetic relay 100 as shown in FIG. 1A. However, this is only an example and should not be construed as limiting. The contact device 1 does not have to be applied to the electromagnetic relay 100 but may also be used in a breaker (circuit breaker), a switch, or any other type of electrical equipment. Also, in the embodiment to be described below, the electromagnetic relay 100 is supposed to be used as a part of onboard equipment for an electric vehicle (EV). In that case, the fixed terminals 31, 32 and moving contactor 8 of the contact device 1A are electrically connected on a high-potential side of the path along which DC power is supplied from a traveling battery E1 to a load R1 (such as an inverter), and the fixed terminals 31, 32 and moving contactor 8 of the contact device 1B are electrically connected on a low-potential side of the path, as shown in FIG. 6.

(1.2) Contact Device

Next, a configuration for the contact devices 1 will be described.

As shown in FIGS. 1A and 1B, each contact device 1 includes the pair of fixed terminals 31, 32, the moving contactor 8, a housing 4, a flange 5, and two bus bars 21, 22. The contact device 1 further includes a first yoke 6, a second yoke 7, two capsule yokes 23, 24, two arc extinction magnets (permanent magnets) 25, 26, an insulation plate 41, and a spacer 45. The fixed terminal 31 holds the fixed contact 311 thereon, and the fixed terminal 32 holds the fixed contact 321 thereon. The moving contactor 8 is a plate member made of a metallic material with electrical conductivity. The moving contactor 8 holds a pair of moving contacts 81, 82, which are arranged to face the pair of fixed contacts 311, 321, respectively.

In the following description, in the contact device 1A, the direction in which the fixed contacts 311, 321 and the moving contacts 81, 82 face each other is defined herein to be an upward/downward direction, and the fixed contacts 311, 321 are located on an upper side when viewed from the moving contacts 81, 82, just for the sake of convenience. In addition, in the contact device 1A, the direction in which the pair of fixed terminals 31, 32 (i.e., the pair of fixed contact 311, 321) are arranged side by side is defined herein to be a rightward/leftward direction, and the fixed terminal 32 is supposed to be located on the right when viewed from the fixed terminal 31. That is to say, in the following description, the upward, downward, rightward, and leftward directions are supposed to be defined on the basis of the directions shown in FIG. 1B. Furthermore, in the following description, the direction perpendicular to both the upward/downward direction and the rightward/leftward direction (i.e., the direction coming out of the paper on which FIG. 1B is depicted) is defined herein to be a forward/backward direction. Note that these directions should not be construed as limiting a mode of using the contact module 91, the contact devices 1, the electromagnetic relay module 910, or the electrical device 900.

The contact device 1A and the contact device 1B have the same configuration but the contact device 1B is arranged with respect to the contact device 1A such that the respective members of the contact device 1B are inverted both in the upward/downward direction and the rightward/leftward direction with respect to their counterparts of the contact device 1A. In the following description, only the constituent elements of the contact device 1A will be described. Description of the corresponding constituent elements of the contact device 1B will be omitted herein, because those constituent elements of the contact device 1B are just arranged upside down with respect to their counterparts of the contact device 1A.

One (first) fixed contact 311 is held at the lower end (one end) of one (first) fixed terminal 31. The other (second) fixed contact 321 is held at the lower end (one end) of the other (second) fixed terminal 32.

The pair of fixed terminals 31, 32 are arranged side by side in the rightward/leftward direction (see FIG. 1B). Each of the pair of fixed terminals 31, 32 is made of an electrically conductive metallic material. The pair of fixed terminals 31, 32 serve as terminals for connecting an external circuit (including a battery and a load) to the pair of fixed contacts 311, 321. In this embodiment, the fixed terminals 31, 32 are supposed to be made of copper (Cu), for example. However, this is only an example and should not be construed as limiting. Alternatively, the fixed terminals 31, 32 may also be made of any electrically conductive material other than copper.

Each of the pair of fixed terminals 31, 32 is formed in the shape of a cylinder, of which a cross section, taken along a plane intersecting with the upward/downward direction at right angles, is circular. In this embodiment, each of the pair of fixed terminals 31, 32 is formed in a T-shape in a front view such that its diameter at the upper end (at the other end) is larger than its diameter at the lower end (at the one end). The pair of fixed terminals 31, 32 are each held by the housing 4 such that part of the fixed terminal 31, 32 protrudes (at the other end) from the upper surface of the housing 4. Specifically, each of the pair of fixed terminals 31, 32 is fixed onto the housing 4 so as to run through an opening cut through the upper wall of the housing 4.

The moving contactor 8 is formed in the shape of a plate having thickness in the upward/downward direction and having a greater dimension in the rightward/leftward direction than in the forward/backward direction. The moving contactor 8 is arranged under the pair of fixed terminals 31, 32 such that both longitudinal ends thereof (i.e., both ends thereof in the rightward/leftward direction) face the pair of fixed contacts 311, 321 (see FIG. 1B). Portions, respectively facing the pair of fixed contacts 311, 321, of the moving contactor 8 are provided with the pair of moving contacts 81, 82, respectively (see FIG. 1B).

The moving contactor 8 is housed in the housing 4. The moving contactor 8 is moved up and down (i.e., in the upward/downward direction) by the electromagnet device 10 arranged under the housing 4, thus allowing the moving contactor 8 to move from the closed position to the open position, and vice versa. FIG. 1B illustrates a state where the moving contactor 8 is currently located at the closed position. In this state, the pair of moving contacts 81, 82 held by the moving contactor 8 are in contact with their associated fixed contacts 311, 321, respectively. On the other hand, in a state where the moving contactor 8 is currently located at the open position, the pair of moving contacts 81, 82 held by the moving contactor 8 are out of contact with their associated fixed contacts 311, 321, respectively.

Therefore, when the moving contactor 8 is currently located at the closed position, the pair of fixed terminals 31, 32 are short-circuited together via the moving contactor 8. That is to say, when the moving contactor 8 is currently located at the closed position, the moving contacts 81, 82 come into contact with the fixed contacts 311, 321, respectively, and therefore, the fixed terminal 31 is electrically connected to the fixed terminal 32 via the fixed contact 311, the moving contact 81, the moving contactor 8, the moving contact 82, and the fixed contact 321. In this embodiment, a positive electrode of the battery E1 is electrically connected to the fixed terminal 31 of the contact device 1A and the load R1 is electrically connected to the fixed terminal 32 of the contact device 1A as shown in FIG. 6. In addition, a negative electrode of the battery E1 is electrically connected to the fixed terminal 32 of the contact device 1B and the load R1 is electrically connected to the fixed terminal 31 of the contact device 1B. Thus, while the moving contactor 8 is currently located at the closed position in each of the contact devices 1A, 1B, the contact device 1A, 1B forms a path through which DC power is supplied from the battery E1 to the load R1.

In this embodiment, the moving contacts 81, 82 only need to be held by the moving contactor 8. Therefore, the moving contacts 81, 82 may be formed by hammering out portions of the moving contactor 8, for example, so as to form integral parts of the moving contactor 8. Alternatively, the moving contacts 81, 82 may be members provided separately from the moving contactor 8 and may be secured, by welding, for example, onto the moving contactor 8. Likewise, the fixed contacts 311, 321 only need to be held by the fixed terminals 31, 32, respectively. Therefore, the fixed contacts 311, 321 may form integral parts of the fixed terminals 31, 32, respectively. Alternatively, the fixed contacts 311, 321 may be members provided separately from the fixed terminals 31, 32 and may be secured, by welding, for example, onto the fixed terminals 31, 32, respectively.

The moving contactor 8 has a through hole 83 at a middle portion thereof. In this embodiment, the through hole 83 is provided at a halfway point between the pair of moving contacts 81, 82 of the moving contactor 8. The through hole 83 runs through the moving contactor 8 along the thickness thereof (i.e., in the upward/downward direction). The through hole 83 is provided to pass a shaft 15 (to be described later) therethrough.

The first yoke 6 is configured as a ferromagnetic body and may be made of a metallic material such as iron. The first yoke 6 is secured to the tip (upper end) of the shaft 15. The shaft 15 runs through the moving contactor 8 through the through hole 83 thereof and the tip (upper end) of the shaft 15 protrudes upward from the upper surface of the moving contactor 8. Thus, the first yoke 6 is located over the moving contactor 8 (see FIG. 1B). Specifically, in the direction in which the moving contactor 8 moves, the first yoke 6 is located on the same side as the fixed contacts 311, 321 with respect to the moving contactor 8.

When the moving contactor 8 is currently located at the closed position, a predetermined gap L1 is left between the moving contactor 8 and the first yoke 6 (see FIG. 4). That is to say, when the moving contactor 8 is located at the closed position, the first yoke 6 is spaced from the moving contactor 8 by the gap L1 in the upward/downward direction. For example, if the moving contactor 8, the shaft 15, and the first yoke 6 are electrically insulated from each other at least partially, then electrical insulation is ensured between the moving contactor 8 and the first yoke 6.

The second yoke 7 is a ferromagnetic body and may be made of a metallic material such as iron. The second yoke 7 is fixed on the lower surface of the moving contactor 8 (see FIG. 1B). Thus, as the moving contactor 8 moves up and down (in the upward/downward direction), the second yoke 7 also moves up and down (in the upward/downward direction). Optionally, an insulating layer 90 with electrical insulation properties may be provided on the upper surface (particularly, a portion to come in contact with the moving contactor 8) of the second yoke 7 (see FIG. 4). This ensures electrical insulation between the moving contactor 8 and the second yoke 7. Note that in FIGS. 1B, 2, 8, 10, 11, 12, and other drawings, illustration of the insulating layer 90 is omitted as appropriate.

The second yoke 7 also has a through hole 71 at a middle portion thereof. In this embodiment, the through hole 71 is aligned with the through hole 83 of the moving contactor 8. The through hole 71 runs through the second yoke 7 along the thickness thereof (i.e., in the upward/downward direction). The through hole 71 is provided to pass the shaft 15 and a contact pressure spring 17 (to be described later) therethrough.

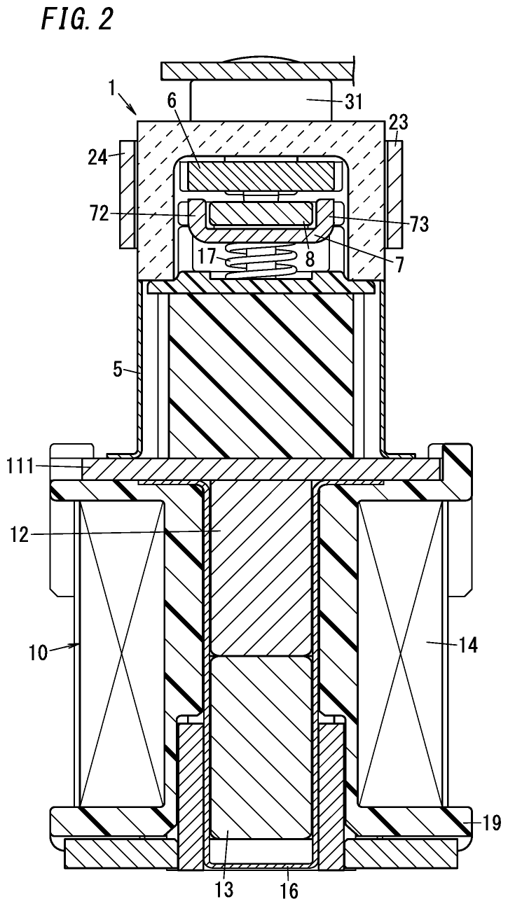

The second yoke 7 has, at both ends in the forward/backward direction, a pair of protrusions 72, 73 protruding upward (see FIG. 2). In other words, at both ends in the forward/backward direction of the upper surface of the second yoke 7, provided are protrusions 72, 73 protruding in the direction in which the moving contactor 8 moves from the open position toward the closed position (i.e., upward in this embodiment). That is to say, at least part of the second yoke 7 is located opposite from the fixed contacts 311, 321 with respect to the moving contactor 8 in the direction in which the moving contactor 8 moves.

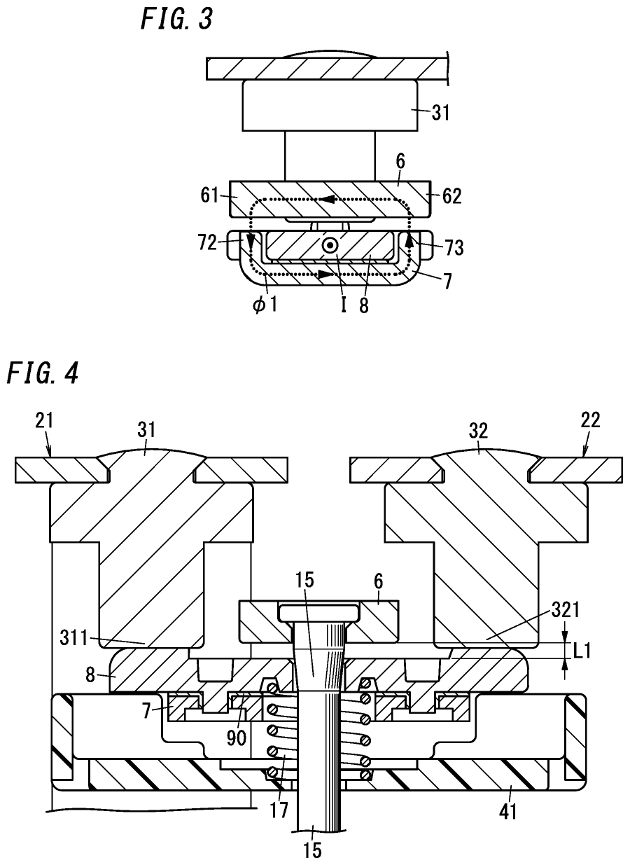

When the second yoke 7 has such a shape, the tip surface (i.e., upper end face) of the front protrusion 72, out of the pair of protrusions 72, 73, is abutted on a frontend portion 61 of the first yoke 6, while the tip surface (i.e., upper end face) of the rear protrusion 73, out of the pair of protrusions 72, 73, is abutted on a rear end portion 62 of the first yoke 6 as shown in FIG. 3. Thus, when an electric current I flows through the moving contactor 8 in the direction shown as an example in FIG. 3, a magnetic flux φ1 is generated to pass through a magnetic path formed by the first yoke 6 and the second yoke 7. At this time, the frontend portion 61 of the first yoke 6 and the tip surface of the protrusion 73 turn into N pole and the rear end portion 62 of the first yoke 6 and the tip surface of the protrusion 72 turn into S pole, thus producing attractive force between the first yoke 6 and the second yoke 7.

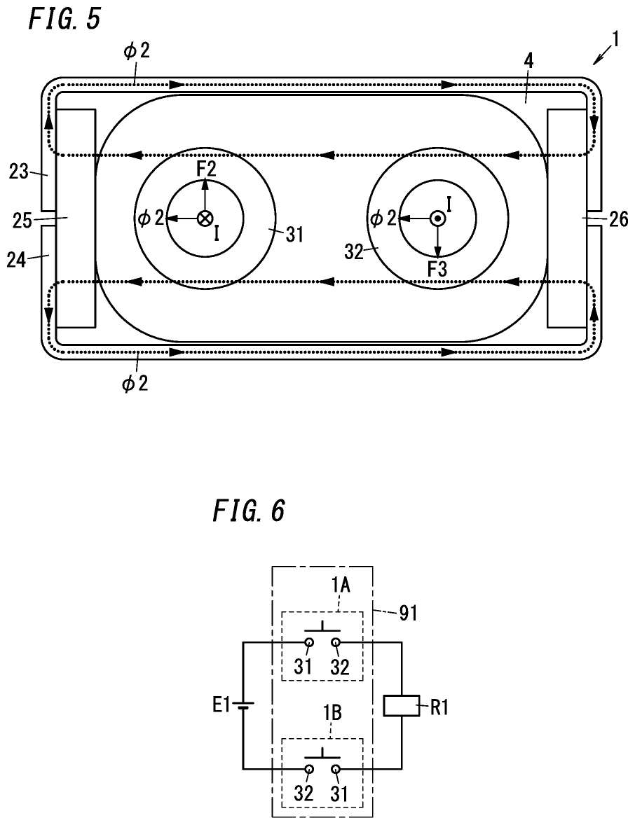

The capsule yokes 23, 24 are configured as ferromagnetic bodies and may be made of a metallic material such as iron. The capsule yokes 23, 24 each hold an arc extinction magnet 25, 26. The capsule yokes 23, 24 are arranged on both sides in the forward/backward direction (i.e., in front of and behind) with respect to the housing 4 so as to surround the housing 4 on both sides in the forward/backward direction (see FIG. 5). In FIG. 5, illustration of the bus bars 21, 22 is omitted.

The arc extinction magnets 25, 26 are arranged such that their poles facing each other in the rightward/leftward direction have mutually opposite polarities. In other words, the arc extinction magnets 25, 26 are arranged as extensions in the direction in which an electric current I flows through the moving contactor 8. The arc extinction magnets 25, 26 are arranged at right and left ends of the housing 4. The arc extinction magnets 25, 26 stretch the arc generated between the moving contacts 81, 82 and the fixed contacts 311, 321 while the moving contactor 8 moves from the closed position toward the open position. The capsule yokes 23, 24 encapsulate the housing 4 as well as the arc extinction magnets 25, 26 in their entirety. In other words, the arc extinction magnets 25, 26 are interposed between the right and left end faces of the housing 4 and the capsule yokes 23, 24. Specifically, one surface in the rightward/leftward direction (i.e., left end face) of one (left) arc extinction magnet 25 is coupled to one end of the capsule yokes 23, 24 and the other surface in the rightward/leftward direction (i.e., right end face) of the arc extinction magnet 25 is coupled to the housing 4. One surface in the rightward/leftward direction (i.e., right end face) of the other (right) arc extinction magnet 26 is coupled to the other end of the capsule yokes 23, 24 and the other surface in the rightward/leftward direction (i.e., left end face) of the arc extinction magnet 26 is coupled to the housing 4. In this embodiment, the arc extinction magnets 25, 26 are arranged such that their poles facing each other in the rightward/leftward direction have mutually opposite polarities. However, this is only an example and should not be construed as limiting. Alternatively, the arc extinction magnet 25, 26 may also be arranged such that their poles facing each other in the rightward/leftward direction have the same polarity.

In this embodiment, while the moving contactor 8 is currently located at the closed position, the respective points of contact between the pair of fixed contacts 311, 321 and the pair of moving contacts 81, 82 are located between the arc extinction magnets 25, 26 (see FIG. 1B). That is to say, the respective points of contact between the pair of fixed contacts 311, 321 and the pair of moving contacts 81, 82 fall within a magnetic field generated between the arc extinction magnets 25, 26.

According to this configuration, the capsule yoke 23 forms part of a magnetic circuit, through which a magnetic flux φ2 generated by the pair of arc extinction magnets 25, 26 passes, as shown in FIG. 5. Likewise, the capsule yoke 24 also forms part of a magnetic circuit, through which a magnetic flux φ2 generated by the pair of arc extinction magnets 25, 26 passes, as shown in FIG. 5. These magnetic fluxes φ2 have magnetic effect on the points of contact between the pair of fixed contacts 311, 321 and the pair of moving contacts 81, 82 in a state where the moving contactor 8 is currently located at the closed position.

In the example illustrated in FIG. 5, in the internal space of the housing 4, leftward magnetic fluxes φ2 are supposed to have been generated, a downward electric current I is supposed to flow through the fixed terminal 31, and an upward electric current I is supposed to flow through the fixed terminal 32. When the moving contactor 8 moves from the closed position toward the open position in such a state, an electric discharge current (arc) is generated downward from the fixed contact 311 toward the moving contact 81 between the fixed contact 311 and the moving contact 81. Thus, the magnetic flux φ2 applies backward Lorenz force F2 to the arc (see FIG. 5). As a result, the arc generated between the fixed contact 311 and the moving contact 81 is stretched backward to be extinct. On the other hand, an electric discharge current (arc) is generated upward from the moving contact 82 toward the fixed contact 321 between the fixed contact 321 and the moving contact 82. Thus, the magnetic flux φ2 applies forward Lorenz force F3 to the arc (see FIG. 5). As a result, the arc generated between the fixed contact 321 and the moving contact 82 is stretched forward to be extinct.

The housing 4 may be made of a ceramic material such as aluminum oxide (alumina). The housing 4 is formed in the shape of a hollow rectangular parallelepiped, of which the dimension is greater in the rightward/leftward direction than in the forward/backward direction (see FIG. 1B). The lower surface of the housing 4 is open. The housing 4 houses the pair of fixed contacts 311, 321, the moving contactor 8, the first yoke 6, and the second yoke 7. The upper surface of the housing 4 has a pair of openings to pass the pair of fixed terminals 31, 32 therethrough. The pair of openings may be formed in a circular shape, for example, and runs through the upper wall of the housing 4 along the thickness thereof (i.e., in the upward/downward direction). The fixed terminal 31 is passed through one opening and the fixed terminal 32 is passed through the other opening. The pair of fixed terminals 31, 32 and the housing 4 are coupled together by brazing, for example.

The housing 4 only needs to be formed in the shape of a box that houses the pair of fixed contacts 311, 321 and the moving contactor 8. Thus, the housing 4 does not have to be formed in the shape of a hollow rectangular parallelepiped as in this embodiment but may also be formed in the shape of a hollow elliptic cylinder or a hollow polygonal column, for example. That is to say, as used herein, the “box shape” refers to any shape in general which has a space to house the pair of fixed contacts 311, 321 and the moving contactor 8 inside, and therefore, does not have to be a rectangular parallelepiped shape. Furthermore, the housing 4 does not have to be made of a ceramic material but may also be made of an electrical insulating material such as glass or resin or may even be made of a metallic material. In any case, the housing 4 is suitably made of a non-magnetic material so as not to be magnetized with magnetism and turn into a magnetic body.

The flange 5 is made of a non-magnetic metallic material, which may be an austenitic stainless steel such as SUS304. The flange 5 may be formed in the shape of a hollow rectangular parallelepiped elongated in the rightward/leftward direction. The upper and lower surfaces of the flange 5 are open. The flange 5 is arranged between the housing 4 and the electromagnet device 10 (see FIGS. 1B and 2). The flange 5 is hermetically coupled to the housing 4 and a yoke upper plate 111 of the electromagnet device 10 as will be described later. This turns the internal space, surrounded with the housing 4, the flange 5, and the yoke upper plate 111, of the contact device 1 into a hermetically sealed space. The flange 5 does not have to be made of a non-magnetic material but may also be made of an alloy, such as 42 alloy, including iron as a main component.

The insulation plate 41 is made of a synthetic resin and has electrical insulation properties. The insulation plate 41 is formed in the shape of a rectangular plate. The insulation plate 41 is located under the moving contactor 8 to electrically insulate the moving contactor 8 from the electromagnet device 10. The insulation plate 41 has a through hole 42 at a middle portion thereof. In this embodiment, the through hole 42 is aligned with the through hole 83 of the moving contactor 8. The through hole 42 runs through the insulation plate 41 along the thickness thereof (i.e., in the upward/downward direction). The through hole 42 is provided to pass the shaft 15 therethrough.

The spacer 45 is formed in the shape of a cylinder. The spacer 45 may be made of a synthetic resin, for example. The spacer 45 is arranged between the electromagnet device 10 and the insulation plate 41. The upper end of the spacer 45 is coupled to the lower surface of the insulation plate 41 and the lower end of the spacer 45 is coupled to the electromagnet device 10. The insulation plate 41 is supported by the spacer 45. The spacer 45 has a hole to pass the shaft 15 therethrough.

The bus bars 21, 22 are made of a metallic material with electrical conductivity. The bus bars 21, 22 may be made of copper or a copper alloy, for example. The bus bars 21, 22 are each formed in the shape of a band. In this embodiment, the bus bars 21, 22 are formed by subjecting a metal plate to folding. One end of the bus bar 21 may be electrically connected to the fixed terminal 31 of the contact device 1, for example. One end of the bus bar 22 may be electrically connected to the fixed terminal 32 of the contact device 1, for example.

The bus bar 21 includes an electrical path piece 211, which is mechanically connected to the fixed terminal 31. Specifically, the electrical path piece 211 has a generally square shape in a plan view and is caulked to the fixed terminal 31 at a caulking portion 35 of the fixed terminal 31.

The bus bar 22 includes an electrical path piece 221, which is mechanically connected to the fixed terminal 32. Specifically, the electrical path piece 221 has a generally square shape in a plan view and is caulked to the fixed terminal 32 at a caulking portion 36 of the fixed terminal 32.

(1.3) Electromagnet Device

Next, a configuration for the electromagnet device 10 will be described.

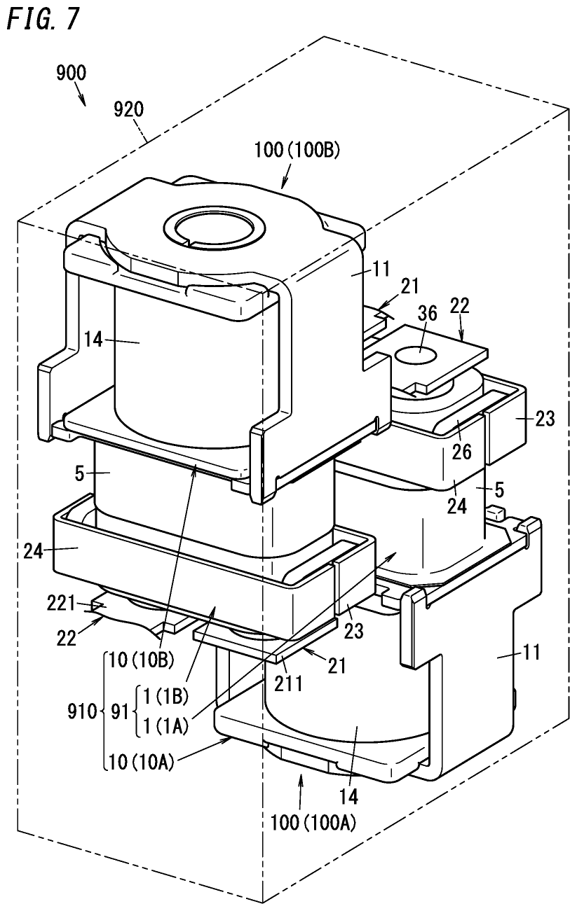

Electromagnet devices 10 are respectively arranged under the contact device 1A and over the contact device 1B (see FIG. 7). Specifically, an electromagnet device 10A is provided under the contact device 1A and an electromagnet device 10B is provided over the contact device 1B. The electromagnetic relay 100A includes the contact device 1A and the electromagnet device 10A. The electromagnetic relay 100B includes the contact device 1B and the electromagnet device 10B. The electromagnet devices 10A and 10B have the same configuration and are just inverted in the upward/downward direction and the rightward/leftward direction. Thus, in the following description, only the configuration of the electromagnet device 10A will be described and description of the electromagnet device 10B will be omitted herein.

As shown in FIGS. 1A and 1B, the electromagnet device 10A includes a stator 12, the mover 13, and the excitation coil 14. When the excitation coil 14 is energized, the electromagnet device 10A has the mover 13 attracted toward the stator 12 by a magnetic field generated by the excitation coil 14, thereby moving the mover 13 upward.

In this embodiment, the electromagnet device 10A includes not only the stator 12, the mover 13, and the excitation coil 14 but also a yoke 11 including the yoke upper plate 111, the shaft 15, a cylindrical body 16, a contact pressure spring 17, a return spring 18, and a coil bobbin 19 as well.

The stator 12 is a fixed iron core formed in the shape of a cylinder protruding downward from a central region of the lower surface of the yoke upper plate 111. The upper end of the stator 12 is secured to the yoke upper plate 111.

The mover 13 is a moving iron core also formed in the shape of a cylinder. The mover 13 is arranged under the stator 12 such that the upper end face of the mover 13 faces the lower end face of the stator 12. The mover 13 is configured to be movable in the upward/downward direction. Specifically, the mover 13 moves from an excitation position where the upper end face thereof is in contact with the lower end face of the stator 12 (see FIGS. 1B and 2) to a non-excitation position where the upper end face thereof is out of contact with the lower end face of the stator 12, and vice versa.

The excitation coil 14 is arranged under the housing 4 such that its center axis is aligned with the upward/downward direction. The stator 12 and the mover 13 are arranged inside the excitation coil 14.

The yoke 11 is arranged to surround the excitation coil 14. The yoke 11 forms, along with the stator 12 and the mover 13, a magnetic circuit through which magnetic fluxes pass when the excitation coil 14 is energized. Thus, the yoke 11, the stator 12, and the mover 13 are all made of a magnetic material (such as a ferromagnetic body). The yoke upper plate 111 forms part of the yoke 11. In other words, at least part of the yoke 11 (i.e., the yoke upper plate 111) is located between the excitation coil 14 and the moving contactor 8.

The contact pressure spring 17 is arranged between the lower surface of the moving contactor 8 and the upper surface of the insulation plate 41. The contact pressure spring 17 is a coil spring that biases the moving contactor 8 upward (see FIG. 1B).

At least part of the return spring 18 is arranged inside the stator 12. The return spring 18 is a coil spring that biases the mover 13 downward (toward the non-excitation position). One end of the return spring 18 is connected to the upper end face of the mover 13 and the other end of the return spring 18 is connected to the yoke upper plate 111 (see FIG. 1B).

The shaft 15 is made of a non-magnetic material. The shaft 15 is formed in the shape of a round rod extending in the upward/downward direction. The shaft 15 transmits the driving force, generated by the electromagnet device 10A, to the contact device 1A provided over the electromagnet device 10A. The shaft 15 passes through the through hole 83, the through hole 71, the inside of the contact pressure spring 17, the through hole 42, the through hole cut through a central region of the yoke upper plate 111, the inside of the stator 12, and the inside of the return spring 18 to have the lower end thereof fixed onto the mover 13. The first yoke 6 is fixed onto the upper end of the shaft 15.

The coil bobbin 19 is made of a synthetic resin. The excitation coil 14 is wound around the coil bobbin 19.

The cylindrical body 16 is formed in the shape of a bottomed cylinder with an open upper surface. The upper end (peripheral portion around the opening) of the cylindrical body 16 is bonded onto the lower surface of the yoke upper plate 111. This allows the cylindrical body 16 to restrict the direction of movement of the mover 13 to the upward/downward direction and also define the non-excitation position of the mover 13. The cylindrical body 16 is hermetically bonded onto the lower surface of the yoke upper plate 111. This allows, even when a through hole is cut through the yoke upper plate 111, the internal space, surrounded with the housing 4, the flange 5, and the yoke upper plate 111, of the contact device 1A to be kept sealed hermetically.

This configuration allows the moving contactor 8 of the contact device 1A to move up and down in the upward/downward direction as the mover 13 moves up and down in the upward/downward direction under the driving force generated by the electromagnet device 10A.

(1.4) Electrical Device

Next, a configuration for the electrical device 900 will be described.

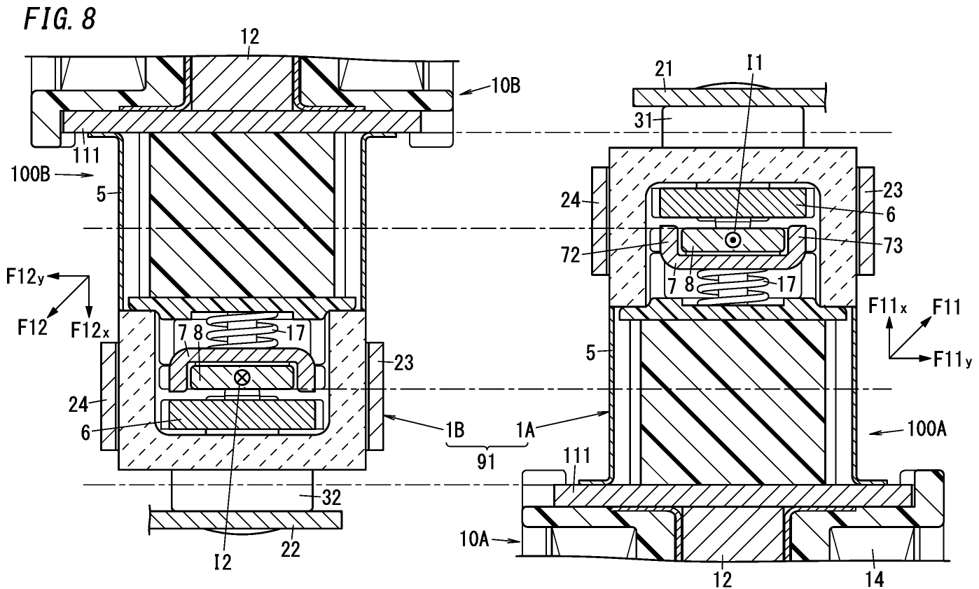

The electrical device 900 includes the two electromagnetic relays 100A, 100B and a holding member 920 for holding the electromagnetic relays 100A, 100B (see FIG. 7). The holding member 920 may be made of a synthetic resin and formed in the shape of a box, for example. The holding member 920 houses the two electromagnetic relays 100 such that the electromagnetic relays 100 are inverted to each other in the upward/downward direction and the rightward/leftward direction. That is to say, the holding member 920 houses the electromagnetic relays 100A, 100B such that the contact device 1A is located over the electromagnet device 10A and that the contact device 1B is located under the electromagnet device 10B. The holding member 920 further houses the electromagnetic relays 100A, 100B such that the electromagnetic relays 100A, 100B are arranged side by side in the forward/backward direction. The holding member 920 further holds the electromagnetic relays 100A, 100B such that the respective positions of the moving contactor 8 of the contact device 1A at the closed position and moving contactor 8 of the contact device 1B at the closed position shift from each other in the direction of movement of the movable contactor 8 (i.e., in the upward/downward direction) (see FIG. 8). Specifically, in the direction of movement (upward/downward direction) of the movable contactor 8, the movable contactor 8 of the contact device 1A at the closed position is arranged between the yoke upper plate 111 of the electromagnet device 10B and the movable contactor 8 of the contact device 1B at the closed position. Furthermore, in the direction of movement of the movable contactor 8 (in the upward/downward direction), the movable contactor 8 of the contact device 1B at the closed position is arranged between the yoke upper plate 111 of the electromagnet device 10A and the movable contactor 8 of the contact device 1A at the closed position.

Alternatively, in the direction of movement of the movable contactor 8 (in the upward/downward direction), the movable contactor 8 of the contact device 1A at the closed position may be arranged under the yoke upper plate 111 of the electromagnet device 10B. Also, in the direction of movement of the movable contactor 8 (in the upward/downward direction), the movable contactor 8 of the contact device 1B at the closed position may be arranged over the yoke upper plate 111 of the electromagnet device 10A.

In this embodiment, in the contact device 1A, the electric current I1 is supposed to be input to the fixed terminal 31 and the input electric current I1 is supposed to be output from the fixed terminal 32 via the movable contactor 8 as shown in FIG. 6. On the other hand, in the contact device 1B, the electric current I2 is supposed to be input to the fixed terminal 32 and the input electric current I2 is supposed to be output from the fixed terminal 31 via the movable contactor 8. That is to say, the contact devices 1A and 1B are arranged so as to be inverted in the rightward/leftward direction. Thus, the direction of the electric current I1 flowing through the movable contactor 8 of the contact device 1A (i.e., the rightward direction) and the direction of the electric current I2 flowing through the movable contactor 8 of the contact device 1B (i.e., the leftward direction) become opposite from each other.

As described above, the contact device 1A and the contact device 1B are connected to the common path along which DC power is supplied from the battery E1 to the load R1. The electromagnet devices 10A, 10B are configured such that the respective movable contactors 8 of the contact devices 1A, 1B move in sync with each other. That is to say, when the movable contactor 8 of the contact device 1A is currently located at the closed position, the movable contactor 8 of the contact device 1B is also located at the closed position. When the movable contactor 8 of the contact device 1A is currently located at the open position, the movable contactor 8 of the contact device 1B is also located at the open position. Thus, the amount of electric current I flowing through the movable contactor 8 of the contact device 1A becomes equal to the amount of electric current I2 flowing through the movable contactor 8 of the contact device 1B.

(2) Operation

Next, it will be described briefly how the electromagnetic relay 100A, including the contact device 1A and electromagnet device 10A with such configurations, operates. The electromagnetic relay 100B operates in the same way as the electromagnetic relay 100A, and therefore, description thereof will be omitted herein.

While the excitation coil 14 is supplied with no electric current (i.e., not energized), no magnetic attractive force is generated between the mover 13 and the stator 12. Thus, in such a situation, the mover 13 is located at the non-excitation position under the spring force applied by the return spring 18. At this time, the shaft 15 has been pulled down to restrict the upward movement of the moving contactor 8. This causes the moving contactor 8 to be located at the open position, which is lower end position of its movable range. This brings the pair of moving contacts 81, 82 out of contact with the pair of fixed contacts 311, 321, thus turning the contact device 1 open. In this state, the pair of fixed terminals 31, 32 are not electrically conductive with each other.

On the other hand, when the excitation coil 14 is energized (i.e., supplied with an electric current), magnetic attractive force is generated between the mover 13 and the stator 12, thus causing the mover 13 to be pulled upward by overcoming the spring force applied by the return spring 18 to reach the excitation position. At this time, the shaft 15 is pushed upward, thus canceling the shaft's 15 restriction on the upward movement of the moving contactor 8. Then, the contact pressure spring 17 biases the moving contactor 8 upward, thus causing the moving contactor 8 to move toward the closed position at the upper end of its movable range. This brings the pair of moving contacts 81, 82 into contact with the pair of fixed contacts 311, 321, thus turning the contact device 1 closed. In this state, the contact device 1 is closed, and therefore, the pair of fixed terminals 31, 32 are electrically conductive with each other.

This allows the electromagnet device 10 to control the attractive force to be applied onto the mover 13 by selectively energizing the excitation coil 14 and to generate driving force for changing the state of the contact device 1 from the open state to the closed state, and vice versa, by moving the mover 13 up and down in the upward/downward direction.

(3) Advantages

When the excitation coil 14 is energized (or supplied with an electric current), the mover 13 moves from the non-excitation position to the excitation position in the electromagnet device 10 as described above. At this time, the driving force generated by the electromagnet device 10 causes the moving contactor 8 to move from the open position toward the closed position. This brings the moving contacts 81, 82 into contact with the fixed contacts 311, 321, thus turning the contact device 1 closed. When the contact device 1 is closed, the contact pressure spring 17 presses the moving contacts 81, 82 against the fixed contacts 311, 321, respectively.

In some cases, when the contact device 1 is closed, electromagnetic repulsion that brings the moving contacts 81, 82 out of contact with the fixed contacts 311, 321 may be caused by an electric current flowing through the contact device 1 (between the fixed terminals 31, 32) That is to say, when an electric current flows through the contact device 1, the Lorenz force sometimes causes the electromagnetic repulsion to the moving contactor 8 in such a direction as to move the moving contactor 8 from the closed position toward the open position (i.e., downward). The electromagnetic repulsion is ordinarily less than the spring force applied by the contact pressure spring 17, thus allowing the moving contactor 8 to keep the moving contacts 81, 82 in contact with the fixed contacts 311, 321. Nevertheless, when a significant amount of electric current (of about 6 kA, for example) such as a short-circuit current flows (as an abnormal electric current) through the contact device 1, the electromagnetic repulsion applied to the moving contactor 8 could be greater than the spring force applied by the contact pressure spring 17. In this embodiment, an electric current flowing through the respective moving contactors 8 of the contact devices 1A, 1B is used as a countermeasure against such electromagnetic repulsion.

In the contact module 91 according to this embodiment, the direction in which the electric current I1 flows through the moving contactor 8 of the contact device 1A and the direction in which the electric current I2 flows through the moving contactor 8 of the contact device 1B become opposite from each other. Thus, when an abnormal electric current such as a short-circuit current flows through the contact devices 1A, 1B, repulsive forces F11, F12 are produced between the moving contactor 8 of the contact device 1A and the moving contactor 8 of the contact device 1B (see FIG. 8). As used herein, the “repulsive forces F11, F12” refer to forces applied in mutually opposite directions, among the forces interacting between the moving contactor 8 of the contact device 1A and the moving contactor 8 of the contact device 1B. Such repulsive forces F11, F12 are forces that the electric current I1 flowing through the moving contactor 8 of the contact device 1A and the electric current I2 flowing through the moving contactor 8 of the contact device 1B receive under the Lorenz force.

When the respective moving contactors 8 of the contact devices 1A and 1B are each located at the closed position, the moving contactor 8 of the contact device 1A is located, in the direction of movement of the moving contactors 8, between the fixed terminals 31, 32 of the contact device 1A and the moving contactor 8 of the contact device 1B. On the other hand, when the respective moving contactors 8 of the contact devices 1A and 1B are each located at the closed position, the moving contactor 8 of the contact device 1B is located, in the direction of movement of the moving contactors 8, between the fixed terminals 31, 32 of the contact device 1B and the moving contactor 8 of the contact device 1A. The respective moving contactors 8 of the contact devices 1A, 1B are movable in the upward/downward direction. The repulsive forces produced between the respective moving contactors 8 of the contact devices 1A, 1B cause the forces F11, F12 to be applied to the respective moving contactors 8 of the contact devices 1A, 1B (see FIG. 8). Out of force components F11x and F11y, respectively produced in the upward/downward direction and the forward/backward direction, of the force F11, the force component F11x is applied to the moving contactor 8 of the contact device 1A. On the other hand, out of force components F12x and F12y, respectively produced in the upward/downward direction and the forward/backward direction, of the force F12, the force component F12x is applied to the moving contactor 8 of the contact device 1B.

Thus, force in the direction from the open position toward the closed position (i.e., upward force) is applied to the moving contactor 8 of the contact device 1A by the magnetic field generated by the moving contactor 8 of the contact device 1B. On the other hand, force in the direction from the open position toward the closed position (i.e., downward force) is applied to the moving contactor 8 of the contact device 1B by the magnetic field generated by the moving contactor 8 of the contact device 1A. This increases the force with which the moving contactor 8 is pressed against the fixed contacts 311, 312 in each of the contact devices 1A, 1B.

This increases, even when an abnormal electric current such as a short-circuit current flows through each of the contact devices 1A, 1B, the stability of connection between the moving contacts 81, 82 and fixed contacts 311, 321 in each of the contact devices 1A, 1B.

(4) Variations

In a contact module 91a according to a variation, the relative positions of the contact devices 1A and 1B are different from those of the contact module 91 described above.

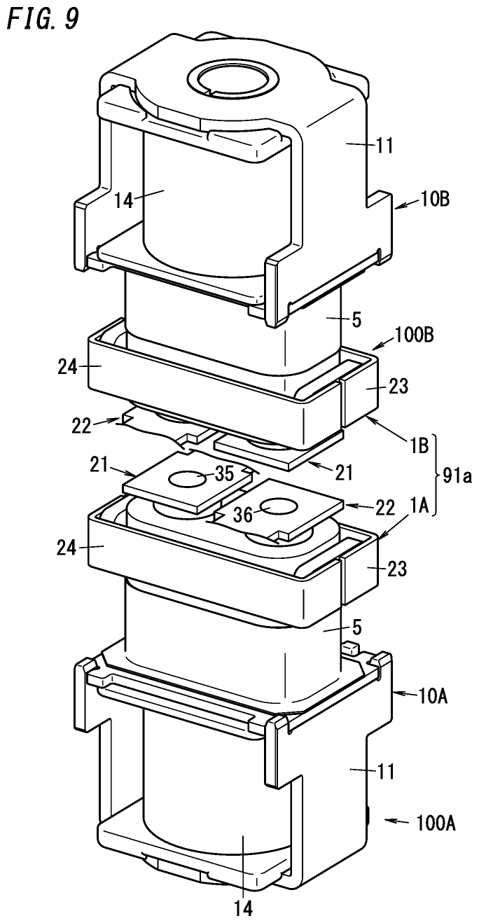

Specifically, according to this variation, the contact devices 1A, 1B are laid one on of the other in the upward/downward direction (see FIG. 9). The contact device 1B is arranged over the contact device 1A so as to be inverted both in the upward/downward direction and the rightward/leftward direction with respect to the contact device 1A. Therefore, the moving contactor 8 of the contact device 1A and the moving contactor 8 of the contact device 1B face each other in the upward/downward direction.

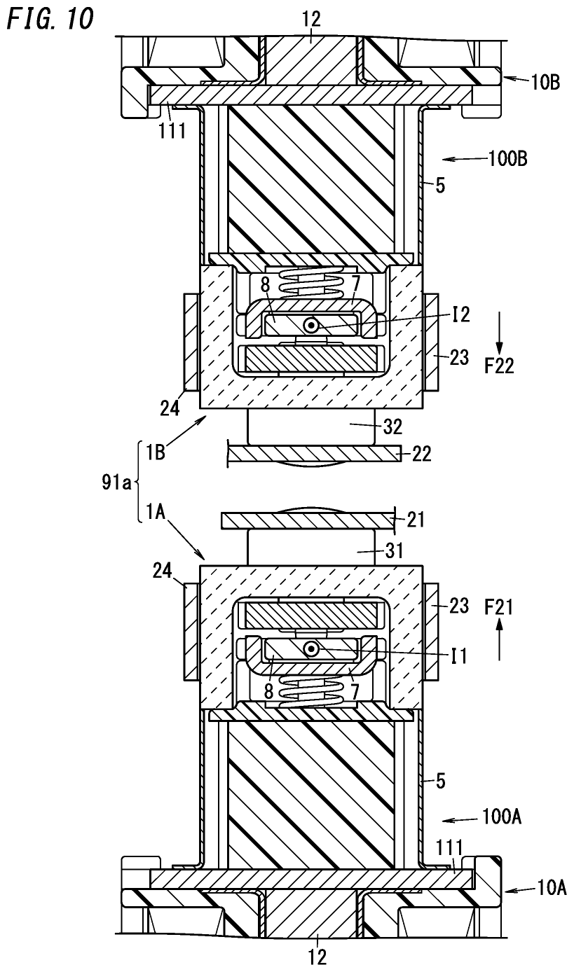

In this variation, in the contact device 1A, the electric current I1 is supposed to be input to the fixed terminal 31 and the input electric current I1 is supposed to be output through the fixed terminal 32 via the moving contactor 8. On the other hand, in the contact device 1B, the electric current I2 is supposed to be input to the fixed terminal 32 and the input electric current I2 is supposed to be output through the fixed terminal 31 via the moving contactor 8. That is to say, the direction of the electric current I1 flowing through the moving contactor 8 of the contact device 1A (i.e., the rightward direction) and the direction of the electric current I2 flowing through the moving contactor 8 of the contact device 1B (i.e., the rightward direction) are the same (see FIG. 10).

Thus, the Lorenz force produces attractive force between the moving contactor 8 of the contact device 1A and the moving contactor 8 of the contact device 1B. Specifically, the moving contactor 8 of the contact device 1A is subjected to force F21 applied in the direction from the open position toward the closed position (i.e., the upward direction) by the magnetic field generated by the moving contactor 8 of the contact device 1B. On the other hand, the moving contactor 8 of the contact device 1B is subjected to force F22 applied in the direction from the open position toward the closed position (i.e., the downward direction) by the magnetic field generated by the moving contactor 8 of the contact device 1A. As a result, in each of the contact devices 1A, 1B, the force with which the moving contactor 8 is pressed against the fixed contact 311, 321 increases. This reduces, even when a large amount of current flows between the fixed terminals 31, 32 in each of the contact devices 1A, 1B, the chances of the electromagnetic repulsion bringing the pair of fixed contacts 311, 321 out of contact with the pair of moving contacts 81, 82.

### Second Embodiment

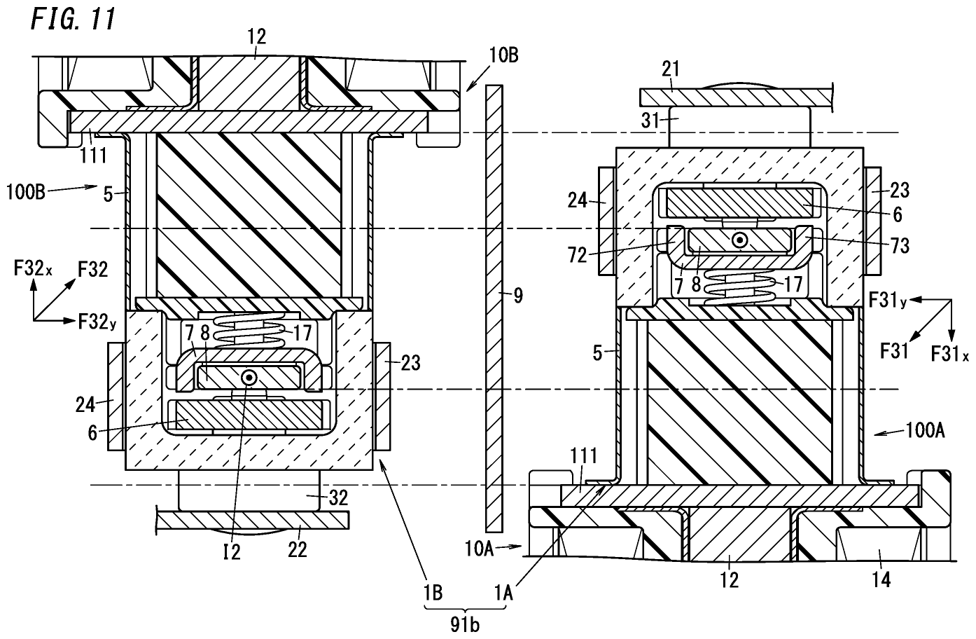

A contact module 91b according to a second embodiment includes the contact devices 1A, 1B, and a magnetic shield member 9 (see FIG. 11).

As in the contact module 91 according to the first embodiment, the contact devices 1A and 1B are arranged side by side in the forward/backward direction, and the contact device 1B is arranged so as to be inverted both in the upward/downward direction and the rightward/leftward direction with respect to the contact device 1A.

The magnetic shield member 9 is made of a magnetic material (such as magnetic steel) and formed in the shape of a rectangular plate. The magnetic shield member 9 is arranged to have its thickness aligned with the forward/backward direction to separate the contact device 1A from the contact device 1B.

The magnetic shield member 9 reduces the force applied in the direction from the closed position toward the open position to the respective moving contactors 8 of the contact devices 1A and 1B. In this embodiment, in the contact device 1A, the electric current I1 is supposed to be input to the fixed terminal 31 and the input electric current I1 is supposed to be output through the fixed terminal 32 via the moving contactor 8. On the other hand, in the contact device 1B, the electric current I2 is supposed to be input to the fixed terminal 32 and the input electric current I2 is supposed to be output through the fixed terminal 31 via the moving contactor 8. That is to say, the direction of the electric current I1 flowing through the moving contactor 8 of the contact device 1A (i.e., the rightward direction) and the direction of the electric current I2 flowing through the moving contactor 8 of the contact device 1B (i.e., the rightward direction) are the same (see FIG. 11).

Thus, the Lorenz force produces attractive forces between the moving contactor 8 of the contact device 1A and the moving contactor 8 of the contact device 1B. These attractive forces cause forces F31, F32 to be applied to the respective moving contactors 8 of the contact devices 1A, 1B. The respective moving contactors 8 of the contact devices 1A, 1B are movable in the upward/downward direction. Thus, out of a force component F31x in the upward/downward direction and a force component F31y in the forward/backward direction of the force F31, the force component F31x is applied to the moving contactor 8 of the contact device 1A. On the other hand, out of a force component F32x in the upward/downward direction and a force component F32y in the forward/backward direction of the force F32, the force component F32x is applied to the moving contactor 8 of the contact device 1B. That is to say, the moving contactor 8 of the contact device 1A is subjected to the force applied in the direction from the closed position toward the open position (i.e., in the downward direction) by the magnetic field generated by the moving contactor 8 of the contact device 1B. Meanwhile, the moving contactor 8 of the contact device 1B is subjected to the force applied in the direction from the closed position toward the open position (i.e., in the upward direction) by the magnetic field generated by the moving contactor 8 of the contact device 1A.

The magnetic shield member 9 is arranged such that its thickness is perpendicular to the direction of movement of the moving contactors 8 (i.e., the upward/downward direction) (such that its thickness is defined in the forward/backward direction) and that its position in the forward/backward direction is between the contact devices 1A and 1B. Specifically, the magnetic shield member 9 is arranged at a position between the moving contactor 8 of the contact device 1A and the moving contactor 8 of the contact device 1B. As used herein, the position between the moving contactor 8 of the contact device 1A and the moving contactor 8 of the contact device 1B includes at least a position between the upper end of the moving contactor 8 of the contact device 1A at the closed position and the lower end of the moving contactor 8 of the contact device 1B at the closed position in the direction of movement of the moving contactors 8 (i.e., the upward/downward direction). In this embodiment, the magnetic shield member 9 is arranged so as to overlap with (i.e., hide) the electromagnetic relays 100A, 100B in their entirety when viewed in the forward/backward direction. The magnetic shield member 9 may have its position fixed by being fitted into a groove cut on the holding member 920 (see FIG. 7), for example.

The magnetic shield member 9 reduces the magnetic field applied from the moving contactor 8 of the contact device 1A to the moving contactor 8 of the contact device 1B and also reduces the magnetic field applied from the moving contactor 8 of the contact device 1B to the moving contactor 8 of the contact device 1A. This reduces the magnetic flux passing through the respective moving contactors 8 of the contact devices 1A, 1B. Consequently, this reduces the force applied in the direction from the closed position toward the open position to the moving contactor 8 of the contact device 1B by the magnetic field generated by the moving contactor 8 of the contact device 1A. This also reduces the force applied in the direction from the closed position toward the open position to the moving contactor 8 of the contact device 1A by the magnetic field generated by the moving contactor 8 of the contact device 1B. This increases, when the respective moving contactors 8 of the contact devices 1A, 1B are located at the closed position, the stability of connection between the pair of moving contacts 81, 82 and the pair of fixed contacts 311, 321.

Note that the magnetic shield member 9 only needs to have magnetic properties, and therefore, does not have to be configured as a ferromagnetic body alone but may include an additional member as well. For example, the magnetic shield member 9 may also be formed by coating a ferromagnetic body with a synthetic resin or any other suitable material. In addition, the magnetic shield member 9 does not have to be configured as a flat plate but may also be formed in the shape of a net, for example.

(Variations)

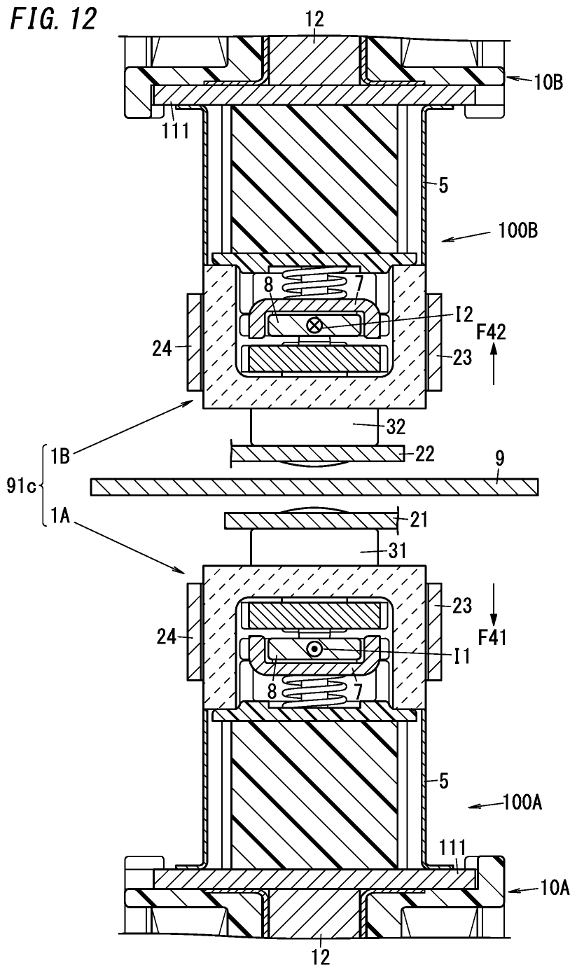

In a contact module 91c according to a variation, the relative positions of the contact devices 1A and 1B are different from those of the contact module 91b described above (see FIG. 12).

Specifically, in this variation, the contact devices 1A, 1B are arranged to be laid one on top of the other in the upward/downward direction as in the contact module 91a according to the variation of the first embodiment. The contact device 1B is arranged over the contact device 1A so as to be inverted both in the upward/downward direction and the rightward/leftward direction with respect to the contact device 1A. Therefore, the respective moving contactors 8 of the contact devices 1A, 1B face each other in the upward/downward direction.

The magnetic shield member 9 is arranged between the respective moving contactors 8 of the contact devices 1A, 1B so as to have its thickness aligned with the upward/downward direction and to separate the contact devices 1A, 1B from each other. In this variation, the magnetic shield member 9 is formed to overlap with (i.e., hide) the electromagnetic relays 100A, 100B in their entirety when viewed in the upward/downward direction.

In this variation, in the contact device 1A, the electric current I1 is supposed to be input to the fixed terminal 31 and the input electric current I1 is supposed to be output through the fixed terminal 32 via the moving contactor 8. On the other hand, in the contact device 1B, the electric current I2 is supposed to be input to the fixed terminal 31 and the input electric current I2 is supposed to be output through the fixed terminal 32 via the moving contactor 8. That is to say, the direction of the electric current I1 flowing through the moving contactor 8 of the contact device 1A (i.e., the rightward direction) and the direction of the electric current I2 flowing through the moving contactor 8 of the contact device 1B (i.e., the leftward direction) are opposite from each other.

Thus, repulsive forces F41, F42 are produced between the moving contactor 8 of the contact device 1A and the moving contactor 8 of the contact device 1B. Specifically, the moving contactor 8 of the contact device 1A is subjected to the force F41 applied in the direction from the closed position toward the open position (i.e., the downward direction) by the magnetic field generated by the moving contactor 8 of the contact device 1B. On the other hand, the moving contactor 8 of the contact device 1B is subjected to the force F42 applied in the direction from the closed position toward the open position (i.e., the upward direction) by the magnetic field generated by the moving contactor 8 of the contact device 1A.

A magnetic shield member 9 is arranged between the respective moving contactors 8 of the contact devices 1A, 1B. The magnetic shield member 9 reduces the magnetic field applied from the moving contactor 8 of the contact device 1A to the moving contactor 8 of the contact device 1B and also reduces the magnetic field applied from the moving contactor 8 of the contact device 1B to the moving contactor 8 of the contact device 1A. This reduces the force applied in the direction from the closed position toward the open position to the moving contactor 8 of the contact device 1B by the magnetic field generated by the moving contactor 8 of the contact device 1A. This also reduces the force applied in the direction from the closed position toward the open position to the moving contactor 8 of the contact device 1A by the magnetic field generated by the moving contactor 8 of the contact device 1B. This increases, when the respective moving contactors 8 of the contact devices 1A, 1B are located at the closed position, the stability of connection between the pair of moving contacts 81, 82 and the pair of fixed contacts 311, 321.

(Other Variations)

Other variations will be enumerated one after another. Any of the variations to be described below may be combined as appropriate with the embodiments described above (including the variations thereof).

In the exemplary embodiments described above and variations thereof, the contact devices 1A, 1B have the same configuration. However, this is only an example and should not be construed as limiting. Alternatively, the contact devices 1A, 1B may have mutually different configurations.

In the exemplary embodiments described above, the housing 4 is configured to partially expose the fixed terminals 31, 32. However, this is only an example and should not be construed as limiting. Alternatively, the housing 4 may house the fixed terminals 31, 32 entirely inside itself. That is to say, the housing 4 only needs to be configured to house the fixed contacts 311, 321 and the moving contactor 8 to say the least.

Also, in the exemplary embodiments described above, the contact device may include no capsule yokes. When provided, the capsule yokes could weaken the repulsive or attractive forces between the moving contactor 8 of the contact device 1A and the moving contactor 8 of the contact device 1B. Thus, removing the capsule yokes curbs such a decrease in repulsive or attractive forces due to the presence of capsule yokes, thus eventually increasing the force with which the moving contactor 8 is pressed against the fixed contacts 311, 321.

Furthermore, in the exemplary embodiment described above, each electromagnetic relay is supposed to be a so-called “normally OFF” electromagnetic relay, of which the moving contactor 8 is located at the open position while the excitation coil 14 is not energized. However, this is only an example and should not be construed as limiting. Alternatively, each electromagnetic relay may also be a normally ON electromagnetic relay.

Furthermore, in the exemplary embodiments described above, the number of moving contacts held by the moving contactor 8 is two. However, this is only an example and should not be construed as limiting. The number of the moving contacts held by the moving contactor 8 may also be one or even three or more. Likewise, the number of the fixed terminals (and fixed contacts) does not have to be two but may also be one or even three or more.

The electromagnetic relay according to the exemplary embodiments is implemented as an electromagnetic relay with no holders. However, this is only an example and should not be construed as limiting. Alternatively, the electromagnetic relay may also be implemented as an electromagnetic relay with a holder. In that case, the holder may have the shape of a rectangular cylinder with the right and left end faces open and may be combined with the moving contactor 8 such that the moving contactor 8 runs through the holder in the rightward/leftward direction. The contact pressure spring 17 is arranged between the lower wall of the holder and the moving contactor 8. That is to say, the moving contactor 8 is held by the holder at a central region thereof in the rightward/leftward direction. The upper end of the shaft 15 is secured to the holder. When the excitation coil 14 is energized, the shaft 15 is pushed upward, and therefore, the holder moves upward. This movement causes the moving contactor 8 to move upward, thereby bringing the pair of moving contacts 81, 82 to the closed position where the pair of moving contacts 81, 82 are in contact with the pair of fixed contacts 311, 321.

Furthermore, in the exemplary embodiments described above, the contact device is implemented as a plunger type contact device. Alternatively, the contact device may also be implemented as a hinged contact device.

Furthermore, in the exemplary embodiments described above, the bus bar 21, 22 is caulked to, and thereby mechanically connected to, the fixed terminals 31, 32. However, this is only an example and should not be construed as limiting. Alternatively, the bus bar 21, 22 may also be mechanically connected with screws onto the fixed terminals 31, 32. Still alternatively, the bus bar may also be coupled to the fixed terminals 31, 32 by welding, brazing, or any other suitable method.

Furthermore, in the exemplary embodiments described above, the arc extinction magnets are arranged outside the housing 4 (i.e., between the capsule yokes and the housing 4).

However, this is only an example and should not be construed as limiting. Alternatively, the arc extinction magnets may also be arranged inside the housing 4.

Furthermore, none of the yokes, arc extinction magnets, and capsule yokes is an essential constituent element for the contact device according to any of the exemplary embodiments.

(Resume)

A contact module (91, 91a) according to a first aspect includes a pair of contact devices (1, 1A, 1B), which consists of one contact device (1A) and the other contact device (1B). The one contact device (1A) includes one fixed terminal (31, 32) and one moving contactor (8). The one fixed terminal (31, 32) has one fixed contact (311, 321). The one moving contactor (8) has one moving contact (81, 82) and moves from a closed position where the one moving contact (81, 82) is in contact with the one fixed contact (311, 321) to an open position where the one moving contact (81, 82) is out of contact with the one fixed contact (311, 321), and vice versa. The other contact device (1B) includes the other fixed terminal (31, 32) and the other moving contactor (8). The other fixed terminal (31, 32) has the other fixed contact (311, 321). The other moving contactor (8) has the other moving contact (81, 82) and moves from a closed position where the other moving contact (81, 82) is in contact with the other fixed contact (311, 321) to an open position where the other moving contact (81, 82) is out of contact with the other fixed contact (311, 321), and vice versa. The pair of contact devices (1, 1A, 1B) is arranged such that a direction in which the one moving contactor (8) of the one contact device (1A) moves from the open position toward the closed position and a direction in which the other moving contactor (8) of the other contact device (1B) moves from the open position toward the closed position are opposite from each other. The one moving contactor (8) generates, when energized, a magnetic field that applies force, in a direction from the open position of the other moving contactor (8) toward the closed position of the other moving contactor (8), to the other moving contactor (8), through which an electric current is flowing. The other moving contactor (8) generates, when energized, a magnetic field that applies force, in a direction from the open position of the one moving contactor (8) toward the closed position of the one moving contactor (8), to the one moving contactor (8), through which an electric current is flowing.

This aspect allows the magnetic field generated by the one moving contactor (8) to increase the force with which the other moving contactor (8) presses the other fixed contact (311, 312) and also allows the magnetic field generated by the other moving contactor (8) to increase the force with which the one moving contactor (8) presses the one fixed contact (311, 312). This increases the stability of connection between the moving contact (81, 82) and the fixed contact (311, 321) in each of the one contact device (1A) and the other contact device (1B).

In a contact module (91) according to a second aspect, which may be implemented in conjunction with the first aspect, the one moving contactor (8) and the other moving contactor (8) are located, in their direction of movement, between the one fixed contact (311, 321) of the one contact device (1A) and the other fixed contact (311, 321) of the other contact device (1B), and have respectively different closed positions. A direction in which the electric current flows through the one moving contactor (8) and a direction in which the electric current flows through the other moving contactor (8) are opposite from each other.

This aspect allows repulsive forces produced between the one moving contactor (8) and the other moving contactor (8) to increase the force with which the one moving contactor (8) presses the one fixed contact (311, 321) and also increase the force with which the other moving contactor (8) presses the other fixed contact (311, 321). This increases the stability of connection between the moving contact (81, 82) and the fixed contact (311, 321) in each of the one contact device (1A) and the other contact device (1B).

In a contact module (91a) according to a third aspect, which may be implemented in conjunction with the first aspect, the one moving contactor (8) and the other moving contactor (8) have, in their direction of movement, respectively different closed positions. The one fixed contact (311, 321) of the one contact device (1A) and the other fixed contact (311, 321) of the other contact device (1B) are located, in respective directions of movement of the one moving contactor (8) and the other moving contactor (8), between the one moving contactor (8) and the other moving contactor (8). A direction in which the electric current flows through the one moving contactor (8) and a direction in which the electric current flows through the other moving contactor (8) are the same.

This aspect allows the attractive force produced between the one moving contactor (8) and the other moving contactor (8) to increase the force with which the one moving contactor (8) presses the one fixed contact (311, 321) and also increase the force with which the other moving contactor (8) presses the other fixed contact (311, 321). This increases the stability of connection between the moving contact (81, 82) and the fixed contact (311, 321) in each of the one contact device (1A) and the other contact device (1B).

A contact module (91b, 91c) according to a fourth aspect includes: a pair of contact devices (1, 1A, 1B) consisting of one contact device (1A) and the other contact device (1B); and a magnetic shield member (9) having magnetic properties. The one contact device (1A) includes one fixed terminal (31, 32) and one moving contactor (8). The one fixed terminal (31, 32) has one fixed contact (311, 321). The one moving contactor (8) has one moving contact (81, 82) and moves from a closed position where the one moving contact (81, 82) is in contact with the one fixed contact (311, 321) to an open position where the one moving contact (81, 82) is out of contact with the one fixed contact (311, 321), and vice versa. The other contact device (1B) includes the other fixed terminal (31, 32) and the other moving contactor (8). The other fixed terminal (31, 32) has the other fixed contact (311, 321). The other moving contactor (8) has the other moving contact (81, 82) and moves from a closed position where the other moving contact (81, 82) is in contact with the other fixed contact (311, 321) to an open position where the other moving contact (81, 82) is out of contact with the other fixed contact (311, 321), and vice versa. The pair of contact devices (1, 1A, 1B) are arranged such that a direction in which the one moving contactor (8) of the one contact device (1A) moves from the open position toward the closed position and a direction in which the other moving contactor (8) of the other contact device (1B) moves from the open position toward the closed position are opposite from each other. The one moving contactor (8) generates, when energized, a magnetic field that applies force, in a direction from the closed position of the other moving contactor (8) toward the open position of the other moving contactor (8), to the other moving contactor (8), through which an electric current is flowing. The other moving contactor (8) generates, when energized, a magnetic field that applies force, in a direction from the closed position of the one moving contactor (8) toward the open position of the one moving contactor (8), to the one moving contactor (8), through which an electric current is flowing. The magnetic shield member (9) is arranged between the one moving contactor (8) and the other moving contactor (8).

This aspect allows the magnetic shield member (9) to weaken the magnetic field applied from the one moving contactor (8) to the other moving contactor (8) and also weaken the magnetic field applied from the other moving contactor (8) to the one moving contactor (8), thus reducing the force applied to the one moving contactor (8) and the other moving contactor (8) in a direction from the closed position toward the open position. This increases the stability of connection between the moving contact (81, 82) and the fixed contact (311, 321) in each of the one contact device (1A) and the other contact device (1B).

In a contact module (91, 91a, 91b, 91c) according to a fifth aspect, which may be implemented in conjunction with any one of the first to fourth aspects, in each of the one contact device (1A) and the other contact device (1B), each of the one and the other fixed terminals (31, 32) includes a first fixed terminal (31) and a second fixed terminal (32). Each of the one and the other fixed contacts (311, 321) includes: a first fixed contact (311) provided for the first fixed terminal (31); and a second fixed contact (321) provided for the second fixed terminal (32). Each of the one and the other moving contacts (81, 82) includes a first moving contact (81) and a second moving contact (82) to come into contact with the first fixed contact (311) and the second fixed contact (321), respectively, when the one or the other moving contactor (8) is located at the closed position.

This aspect increases the stability of connection between the moving contact (81, 82) and the fixed contact (311, 321) in each of the one contact device (1A) and the other contact device (1B).

A contact device (1, 1A, 1B) according to a sixth aspect is included in the contact module (91, 91a, 91b, 91c) according to any one of the first to fifth aspects.

This aspect increases the stability of connection between the moving contact (81, 82) and the fixed contact (311, 321) in each of the contact devices (1, 1A, 1B).

An electromagnetic relay module (910) according to a seventh aspect includes: the contact module (91, 91a, 91b, 91c) according to any one of the first to fifth aspects; and a pair of electromagnet devices (10, 10A, 10B) consisting of one electromagnet device (10A) and the other electromagnet device (10B). The one electromagnet device (10A) moves the one moving contactor (8), while the other electromagnet device (10B) moves the other moving contactor (8).

This aspect increases the stability of connection between the moving contact (81, 82) and the fixed contact (311, 321) in each of the one contact device (1A) and the other contact device (1B).

An electrical device (900) according to an eighth aspect includes: the electromagnetic relay module (910) according to the seventh aspect; and a holding member (920). The holding member (920) holds the electromagnetic relay module (910) such that a direction in which the one moving contactor (8) moves from the open position toward the closed position and a direction in which the other moving contactor (8) moves from the open position toward the closed position are opposite from each other.

This aspect increases the stability of connection between the moving contact (81, 82) and the fixed contact (311, 321) in each of the one contact device (1A) and the other contact device (1B).

Note that the constituent elements according to the second, third, and fifth aspects are not essential constituent elements for the contact module (91, 91a, 91b, 91c) but may be omitted as appropriate.

### REFERENCE SIGNS LIST

1 Contact Device
1A (One) Contact Device
1B (the Other) Contact Device
31 Fixed Terminal (First Fixed Terminal)
311 Fixed Contact (First Fixed Contact)
32 Fixed Terminal (Second Fixed Terminal)
321 Fixed Contact (Second Fixed Contact)
8 Moving Contactor
81 Moving Contact (First Moving Contact)
82 Moving Contact (Second Moving Contact)
9 Magnetic Shield Member
91, 91a, 91b, 91c Contact Module
910 Electromagnetic Relay Module
10, 10A, 10B Electromagnet Device
900 Electrical Device
920 Holding Member

1. A contact module comprising a pair of contact devices, the pair of contact devices consisting of one contact device and the other contact device,
the one contact device including:
one fixed terminal having one fixed contact; and
one moving contactor having one moving contact and configured to move from a closed position where the one moving contact is in contact with the one fixed contact to an open position where the one moving contact is out of contact with the one fixed contact, and vice versa,
the other contact device including:
the other fixed terminal having the other fixed contact; and
the other moving contactor having the other moving contact and configured to move from a closed position where the other moving contact is in contact with the other fixed contact to an open position where the other moving contact is out of contact with the other fixed contact, and vice versa,
the pair of contact devices being arranged such that a direction in which the one moving contactor of the one contact device moves from the open position toward the closed position and a direction in which the other moving contactor of the other contact device moves from the open position toward the closed position are opposite from each other,
the one moving contactor being configured to, when energized, generate a magnetic field that applies force, in a direction from the open position of the other moving contactor toward the closed position of the other moving contactor, to the other moving contactor, through which an electric current is flowing,
the other moving contactor being configured to, when energized, generate a magnetic field that applies force, in a direction from the open position of the one moving contactor toward the closed position of the one moving contactor, to the one moving contactor, through which an electric current is flowing.

2. The contact module of claim 1, wherein
the one moving contactor and the other moving contactor are located, in their direction of movement, between the one fixed contact of the one contact device and the other fixed contact of the other contact device, and have respectively different closed positions, and
a direction in which the electric current flows through the one moving contactor and a direction in which the electric current flows through the other moving contactor are opposite from each other.

3. The contact module of claim 1, wherein
the one moving contactor and the other moving contactor have, in their direction of movement, respectively different closed positions,
the one fixed contact of the one contact device and the other fixed contact of the other contact device are located, in respective directions of movement of the one moving contactor and the other moving contactor, between the one moving contactor and the other moving contactor, and
a direction in which the electric current flows through the one moving contactor and a direction in which the electric current flows through the other moving contactor are the same.

4. A contact module comprising:
a pair of contact devices consisting of one contact device and the other contact device; and
a magnetic shield member having magnetic properties,
the one contact device including:
one fixed terminal having one fixed contact; and
one moving contactor having one moving contact and configured to move from a closed position where the one moving contact is in contact with the one fixed contact to an open position where the one moving contact is out of contact with the one fixed contact, and vice versa,
the other contact device including:
the other fixed terminal having the other fixed contact; and
the other moving contactor having the other moving contact and configured to move from a closed position where the other moving contact is in contact with the other fixed contact to an open position where the other moving contact is out of contact with the other fixed contact, and vice versa,
the pair of contact devices being arranged such that a direction in which the one moving contactor of the one contact device moves from the open position toward the closed position and a direction in which the other moving contactor of the other contact device moves from the open position toward the closed position are opposite from each other,
the one moving contactor being configured to, when energized, generate a magnetic field that applies force, in a direction from the closed position of the other moving contactor toward the open position of the other moving contactor, to the other moving contactor, through which an electric current is flowing,
the other moving contactor being configured to, when energized, generate a magnetic field that applies force, in a direction from the closed position of the one moving contactor toward the open position of the one moving contactor, to the one moving contactor, through which an electric current is flowing,
the magnetic shield member being arranged between the one moving contactor and the other moving contactor.

5. The contact module of claim 1, wherein
in each of the one contact device and the other contact device,
each of the one and the other fixed terminals includes a first fixed terminal and a second fixed terminal,
each of the one and the other fixed contacts includes: a first fixed contact provided for the first fixed terminal; and a second fixed contact provided for the second fixed terminal,
each of the one and the other moving contacts includes a first moving contact and a second moving contact configured to come into contact with the first fixed contact and the second fixed contact, respectively, when the one or the other moving contactor is located at the closed position.

6. A contact device included in the contact module of claim 1.

7. An electromagnetic relay module comprising:
the contact module of claim 1; and
a pair of electromagnet devices consisting of one electromagnet device and the other electromagnet device,
the one electromagnet device being configured to move the one moving contactor, the other electromagnet device being configured to move the other moving contactor.

8. An electrical device comprising:
the electromagnetic relay module of claim 7; and
a holding member configured to hold the electromagnetic relay module such that a direction in which the one moving contactor moves from the open position toward the closed position and a direction in which the other moving contactor moves from the open position toward the closed position are opposite from each other.

9. The contact module of claim 4, wherein
in each of the one contact device and the other contact device,
each of the one and the other fixed terminals includes a first fixed terminal and a second fixed terminal,
each of the one and the other fixed contacts includes: a first fixed contact provided for the first fixed terminal; and a second fixed contact provided for the second fixed terminal,
each of the one and the other moving contacts includes a first moving contact and a second moving contact configured to come into contact with the first fixed contact and the second fixed contact, respectively, when the one or the other moving contactor is located at the closed position.

10. A contact device included in the contact module of claim 4.

11. An electromagnetic relay module comprising:
the contact module of claim 4; and
a pair of electromagnet devices consisting of one electromagnet device and the other electromagnet device,
the one electromagnet device being configured to move the one moving contactor, the other electromagnet device being configured to move the other moving contactor.

12. An electrical device comprising:
the electromagnetic relay module of claim 11; and
a holding member configured to hold the electromagnetic relay module such that a direction in which the one moving contactor moves from the open position toward the closed position and a direction in which the other moving contactor moves from the open position toward the closed position are opposite from each other.
